(19) United States
(12) Patent Application Publication
(10) Pub. No.: US 2026/0152038 A1
(43) Pub. Date: Jun. 4, 2026

(54) VEHICLE AIR CONDITIONING DEVICE

(71) Applicant: TOYOTA JIDOSHA KABUSHIKI KAISHA, Toyota-shi (JP)

(72) Inventor: Hiroshi TAKEUCHI, Toyota-shi (JP)

(73) Assignee: TOYOTA JIDOSHA KABUSHIKI KAISHA, Toyota-shi (JP)

(21) Appl. No.: 19/324,914

(22) Filed: Sep. 10, 2025

(30) Foreign Application Priority Data
Dec. 2, 2024 (JP) 2024-209674

(51) Int. Cl. B60H 1/00

(52) U.S. Cl. CPC B60H 1/00485

(57) ABSTRACT

A vehicle air conditioning device includes a refrigeration circuit in which a refrigerant circulates with a solenoid valve and a heat exchanger provided downstream of the solenoid valve in a refrigerant flow direction, and a pedestal to which the solenoid valve and the heat exchanger are fixed. The pedestal includes a refrigerant inlet, a refrigerant outlet connected to a refrigerant inflow port of the heat exchanger, an internal flow path connected between the refrigerant inlet and the refrigerant outlet, an opening, and a control passage connected from the opening to a portion of the internal flow path. The solenoid valve includes a rod able to reach the portion of the internal flow path from the opening through the control passage. The solenoid valve controls an opening degree of the internal flow path in accordance with an amount by which the rod projects toward the portion of the internal flow path.

### CROSS-REFERENCE TO RELATED APPLICATION

This application claims priority to Japanese Patent Application No. 2024-209674 filed on Dec. 2, 2024. The disclosure of the above-identified application, including the specification, drawings, and claims, is incorporated by reference herein in its entirety.

### BACKGROUND

### 1. Technical Field

The present specification relates to a vehicle air conditioning device, and more particularly, to a vehicle air conditioning device including a unit in which a solenoid valve and a heat exchanger are integrated.

### 2. Description of Related Art

A vehicle air conditioning device includes a refrigeration circuit in which a refrigerant circulates. The refrigeration circuit includes a solenoid valve and a heat exchanger provided on the downstream side of the solenoid valve in the refrigerant flow direction. The heat exchanger exchanges heat between the refrigerant and a cooling liquid, for example. The solenoid valve is provided to switch the presence or absence of the refrigerant to be supplied to the heat exchanger and to adjust the amount of the refrigerant to flow into the heat exchanger.

Japanese Unexamined Patent Application Publication No. 2008-157588 (JP 2008-157588 A) discloses a vehicle air conditioning device including a refrigeration circuit in which carbon dioxide is used as a refrigerant.

### SUMMARY

In a vehicle air conditioning device, a solenoid valve and a heat exchanger are connected by a pipe. Connection parts called joints are disposed at both ends of the pipe. The pipe is connected to the solenoid valve using a joint at one end, and is connected to the heat exchanger using a joint at the other end. However, a space for disposing the pipe and the two joints is required in the vehicle. In order to omit the pipe and the two joints, it is desired to integrate the solenoid valve and the heat exchanger.

The present specification discloses a vehicle air conditioning device in which a solenoid valve and a heat exchanger are integrated.

An aspect disclosed herein provides a vehicle air conditioning device including:
a refrigeration circuit which includes a solenoid valve and a heat exchanger provided on a downstream side of the solenoid valve in a refrigerant flow direction, and in which a refrigerant circulates; and
a pedestal to which the solenoid valve and the heat exchanger are fixed.

The pedestal includes a refrigerant inlet, a refrigerant outlet connected to a refrigerant inflow port of the heat exchanger, an internal flow path having a tunnel shape and connected between the refrigerant inlet and the refrigerant outlet, an opening, and a control passage connected from the opening to a portion of the internal flow path.

The solenoid valve includes a rod that is able to reach the portion of the internal flow path from the opening of the pedestal through the control passage. The solenoid valve controls an opening degree of the internal flow path in accordance with an amount by which the rod projects toward the portion of the internal flow path.

According to this configuration, the solenoid valve and the heat exchanger are connected by the internal flow path of the pedestal, and thus the pipe and the two joints can be omitted. Since the solenoid valve and the heat exchanger are integrated in the pedestal, the space in the vehicle required for the air conditioning device can be reduced.

In the vehicle air conditioning device according to the aspect of the present disclosure,
the solenoid valve may be an expansion valve that reduces a pressure of the refrigerant; and
the heat exchanger may be a chiller into which the refrigerant and a cooling liquid flow and in which the refrigerant is evaporated to absorb heat of the cooling liquid.

In the vehicle air conditioning device according to the aspect of the present disclosure,
the solenoid valve may be a control valve that switches opening and closing of the internal flow path; and
the heat exchanger may be a refrigerant cooler into which the refrigerant and a cooling liquid flow and in which the refrigerant is cooled by the cooling liquid.

Another aspect disclosed herein provides a vehicle air conditioning device including:
a refrigeration circuit which includes a first solenoid valve, a second solenoid valve, and a heat exchanger, and in which a refrigerant circulates; and
a pedestal to which the first solenoid valve, the second solenoid valve, and the heat exchanger are fixed.

The pedestal includes a refrigerant inlet, a first refrigerant outlet connected to a refrigerant inflow port of the heat exchanger, a second refrigerant outlet, and an internal flow path having a tunnel shape.

The internal flow path of the pedestal includes an inlet flow path that extends from the refrigerant inlet, a branch portion that branches from the inlet flow path toward each of the first refrigerant outlet and the second refrigerant outlet, a first flow path connected between the branch portion and the first refrigerant outlet, and a second flow path connected between the branch portion and the second refrigerant outlet.

The pedestal includes a first opening and a first control passage connected from the first opening to a portion of the first flow path. The first solenoid valve includes a first rod that is able to reach to the portion of the first flow path from the first opening of the pedestal through the first control passage. The first solenoid valve controls an opening degree of the first flow path in accordance with an amount by which the first rod projects toward the portion of the first flow path.

The pedestal includes a second opening and a second control passage connected from the second opening to a portion of the second flow path. The second solenoid valve includes a second rod that is able to reach to the portion of the second flow path from the second opening of the pedestal through the second control passage. The second solenoid valve controls an opening degree of the second flow path in accordance with an amount by which the second rod projects toward the portion of the second flow path.

According to this configuration, the first solenoid valve and the heat exchanger are connected by the internal flow path of the pedestal, and the second solenoid valve and the second refrigerant outlet are also connected by the internal flow path of the pedestal. Therefore, a relatively large number of parts (such as a pipe, joints, and a branch pipe) of the air conditioning device can be reduced. Since the two solenoid valves and the heat exchanger are integrated in the pedestal, the space in the vehicle required for the air conditioning device can be reduced.

According to the technique disclosed herein, the solenoid valve and the heat exchanger are integrated, and thus the space in the vehicle required for the air conditioning device can be reduced.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram illustrating a configuration of an air conditioner;

FIG. 2 is a schematic diagram showing a refrigerant flow (solid arrow) during cooling and a refrigerant flow (dotted arrow) during heating;

FIG. 3 is a schematic diagram showing the chiller unit 20 in the upper part, and a schematic diagram showing a comparative technique in the lower part;

FIG. 4A is a perspective view schematically illustrating the chiller unit 20;

FIG. 4B is a cross-sectional view taken along IVB-IVB line of FIG. 4A;

FIG. 5 is a schematic diagram showing another chiller unit 20a in the upper part and a schematic diagram showing a comparative technique in the lower part;

FIG. 6A is a schematic perspective view of a chiller unit 20a.

FIG. 6B is a cross-sectional view taken along VIB-VIB line of FIG. 6A;

FIG. 6C is a cross-sectional view taken along VIC-VIC line of FIG. 6A;

FIG. 7 is a schematic diagram showing the water-cooled GC unit 120 in the upper part, and a schematic diagram showing a comparative technique in the lower part; and

FIG. 8 is a schematic diagram showing another water-cooled GC unit 120a at the upper part, and a schematic diagram showing a comparative technique at the lower part.

### DETAILED DESCRIPTION OF EMBODIMENTS

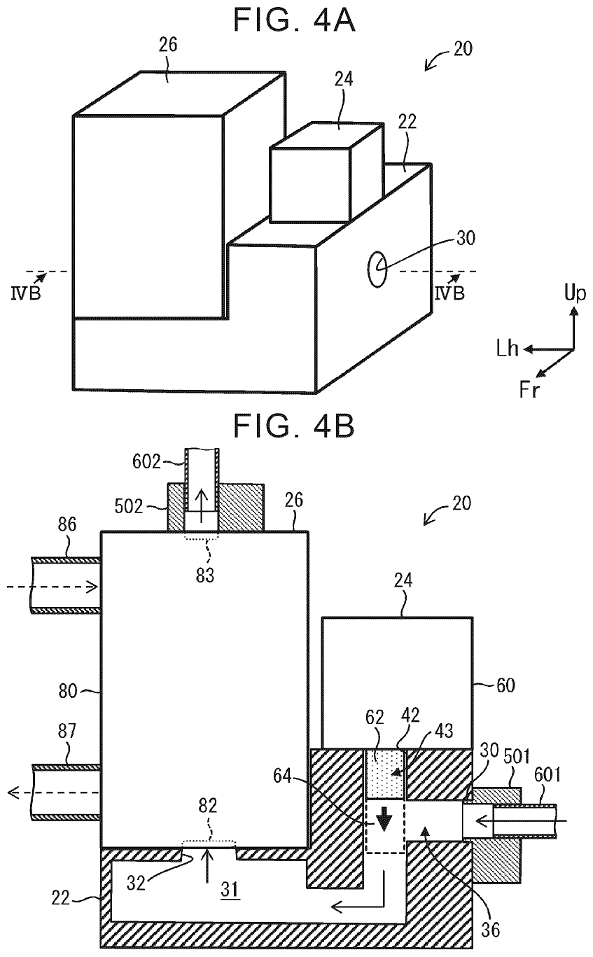

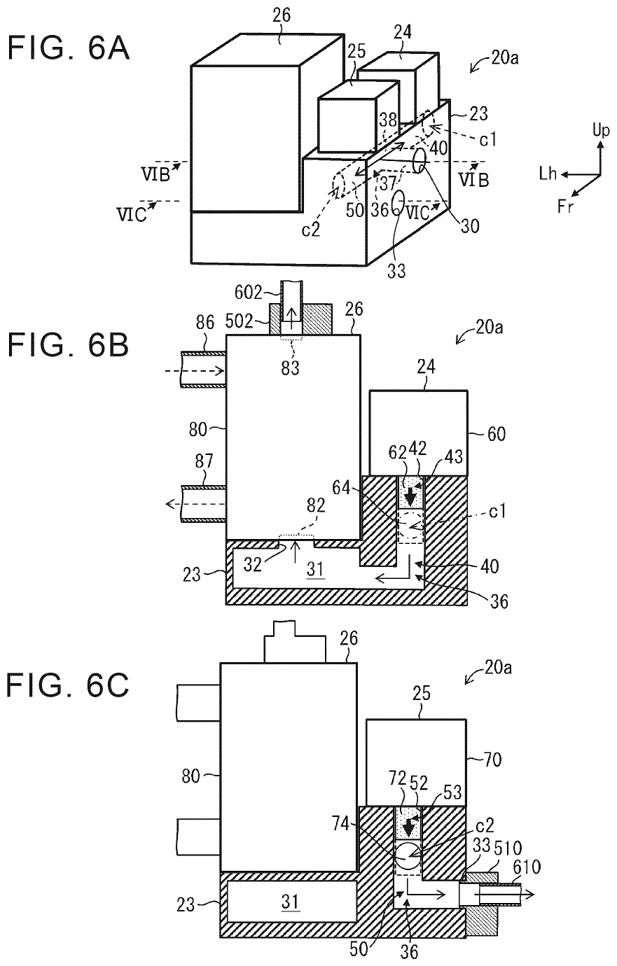

Hereinafter, embodiments will be described with reference to the drawings. In all the drawings, equivalent elements are denoted by the same reference numerals, and redundant description is omitted. In the following description, unless otherwise specified, the phrases representing the front, rear, left, right, up and down directions refer to the direction of the heat exchanger unit. In FIGS. 4A and 6, the direction of the arrow Fr indicates the front side, the direction of the arrow Up indicates the upper side, and the direction of the arrow Lh indicates the left side.

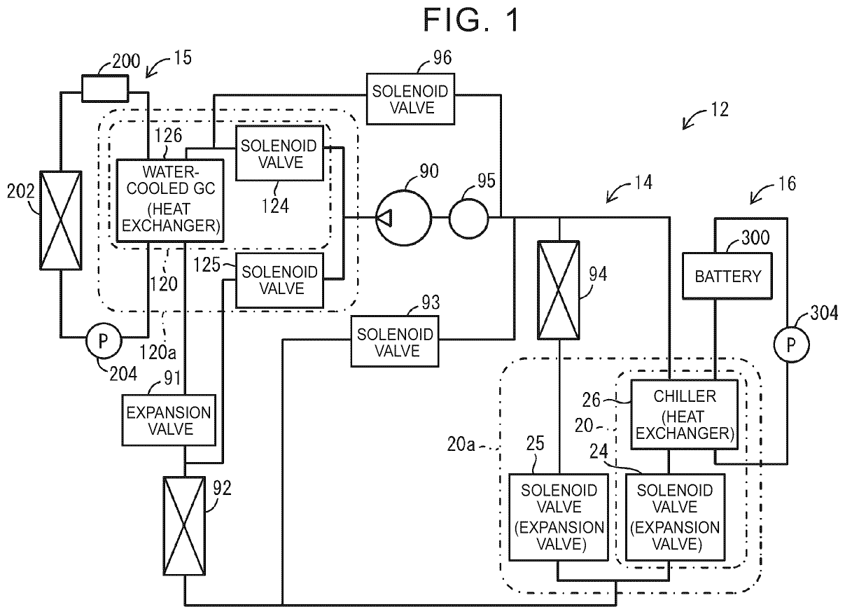

FIG. 1 is a schematic diagram illustrating a configuration of an air conditioner 12. The air conditioner 12 is mounted on an automobile as a vehicle. The air conditioner 12 includes a refrigeration circuit 14, a high-temperature cooling liquid circuit 15, and a low-temperature cooling liquid circuit 16. In the refrigeration circuit 14, the refrigerant circulates. The coolant may be carbon dioxide (R744). In each of the cooling liquid circuits 15 and 16, the coolant circulates.

The refrigeration circuit 14 includes a compressor 90, a solenoid valve 124, a solenoid valve 125, a water-cooled gas cooler 126 (referred to as a water-cooled GC), an expansion valve 91, an air-cooled gas cooler 92 (referred to as an air-cooled GC), a solenoid valve 93, a solenoid valve 24, a chiller 26, a solenoid valve 25, an evaporator 94, an accumulator 95, and a solenoid valve 96. In the refrigeration circuit 14, each device is connected by a refrigerant pipe, an internal flow path of a pedestal described below, and the like.

The water-cooled GC 126 (see FIG. 1) is a heat exchanger (refrigerant cooler) in which the refrigerant and the cooling liquid of the cooling liquid circuit 15 flow in and cool the refrigerant by the cooling liquid. The air-cooled GC 92 is a heat exchanger that exchanges heat between the coolant and the air. The chiller 26 is a heat exchanger in which the refrigerant and the cooling liquid of the cooling liquid circuit 16 flow in, evaporate the refrigerant, and absorb the heat of the cooling liquid of the cooling liquid circuit 16. The evaporator 94 is disposed inside the air-conditioning unit (HVAC: Heating, Ventilation, and Air Conditioning) to cool air blown into the vehicle cabin.

The solenoid valves 24 and 25 function as expansion valves that lower the pressure of the refrigerant. The solenoid valves 24 and 25 control the amount of refrigerant passing through the refrigerant flow path in multiple stages. The solenoid valve 124 functions as a control valve. The solenoid valves 93, 96, 124, and 125 control the refrigerant flow path in two stages of opening and closing. These solenoid valves are connected to a controller (not shown) and operate in accordance with a command output from the controller. The controller is a computer including a processor and a memory.

The high-temperature cooling liquid circuit 15 is configured by sequentially connecting a water-cooled GC 126, a heater 200, a heater core 202, and a pump 204 through coolant pipes. In the cooling liquid circuit 15, the coolant pumped by the pump 204 is heated to a high temperature while passing through the water-cooled GC 126. The hot coolant is sent to the heater core 202. The heater core 202 is disposed inside the air conditioning unit and heats air blown into the vehicle cabin.

The low-temperature cooling liquid circuit 16 is configured by sequentially connecting the chiller 26, the battery 300, and the pump 304 through coolant pipes. The battery 300 supplies electric power to a motor as a power source of the vehicle. In the cooling liquid circuit 16, the coolant pumped by the pump 304 becomes a low temperature due to the heat absorption of the coolant while passing through the chiller 26. The cooled coolant is sent to the battery 300 to cool the battery 300.

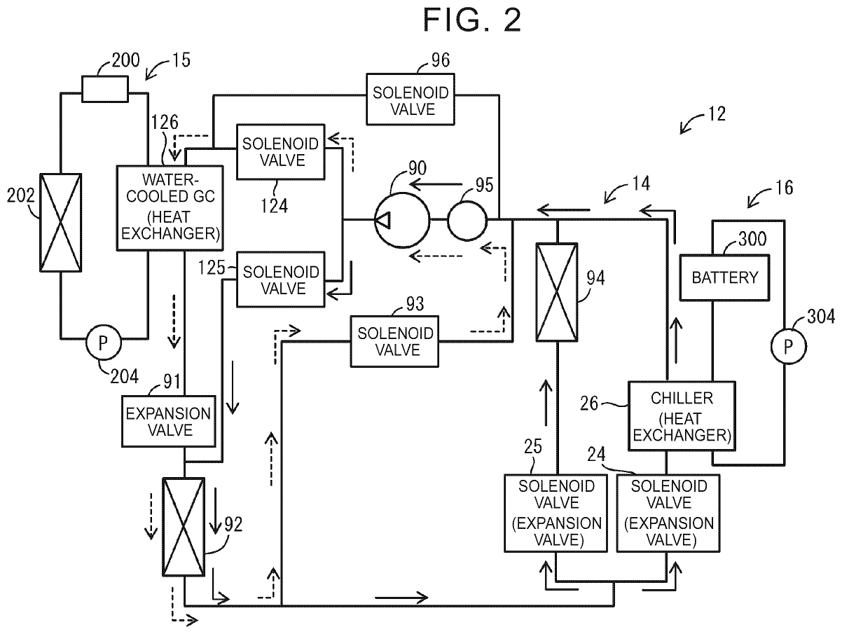

In FIG. 2, the refrigerant flow during cooling is indicated by a solid arrow, and the refrigerant flow during heating is indicated by a dotted arrow. During cooling, the refrigerant circulates through the compressor 90, the solenoid valve 125, the air-cooled GC 92 (heat dissipation of the refrigerant), the solenoid valve 25, the evaporator 94 (heat absorption of the refrigerant), and the accumulator 95 in order. At the time of cooling, the refrigerant flowing out of the air-cooled GC 92 also passes through the solenoid valve 24 and the chiller 26 (heat absorption of the refrigerant), and flows into the accumulator 95.

During heating, the refrigerant circulates through the compressor 90, the solenoid valve 124, the water-cooled GC 126 (heat dissipation of the refrigerant), the expansion valve 91, the air-cooled GC 92 (heat absorption of the refrigerant), the solenoid valve 93, and the accumulator 95 in order.

As shown in FIG. 1, the air conditioner 12 includes a heat exchanger unit in which a solenoid valve and a heat exchanger inside a dashed-dotted line are integrated. The chiller unit 20 is a heat exchanger unit in which the solenoid valve 24 and the chiller 26 are integrated. Further, the chiller unit 20a is a heat-exchanger unit in which the solenoid valve 25 is integrated in addition to the solenoid valve 24 and the chiller 26. In the air conditioner 12, either the chiller unit 20 or the chiller unit 20a is selectively employed.

The water-cooled GC unit 120 is a heat-exchanger unit in which the solenoid valve 124 and the water-cooled GC 126 are integrated. In addition, the water-cooled GC unit 120a is a heat-exchanger unit in which the solenoid valve 124 and the water-cooled GC 126 are further integrated with the solenoid valve 125. In the air conditioner 12, either the water-cooled GC unit 120 or the water-cooled GC unit 120a is selectively employed.

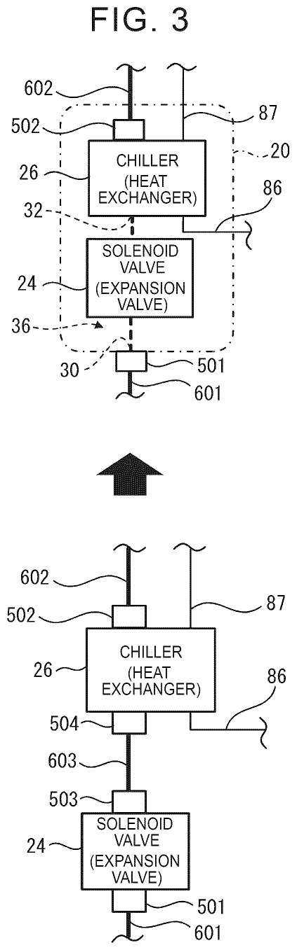

First, the chiller unit 20 will be described. The upper part of FIG. 3 is a schematic diagram showing the chiller unit 20, and the lower part of FIG. 3 is a schematic diagram showing a comparative technique. FIG. 4A is a perspective view schematically showing a chiller unit 20. FIG. 4B is a cross-sectional view taken along IVB-IVB line of FIG. 4A. In FIG. 4B, the cross section of the solenoid valve 24 and the inside of the chiller 26 are omitted.

As shown in FIG. 4A, the chiller unit 20 includes a pedestal 22, a chiller 26, and a solenoid valve 24. The pedestal 22 may be made of aluminum. The pedestal 22 has an L-shape in a cross-sectional view along the upper, lower, left, and right directions, and has a predetermined thickness in the front-rear direction. The pedestal 22 has a stepped shape in which the left portion is one step lower than the right portion.

The chiller 26 is fixed to an upper surface (a stepped-down portion) of a left portion of the pedestal 22. The solenoid valve 24 is fixed to the upper surface of the right portion of the pedestal 22 (step-up portion). The chiller 26 and the solenoid valve 24 may be fixed to the pedestal 22 by screw fastening, brazing, or the like.

The solenoid valve 24 includes a main body 60 and rods 62 (see FIG. 4B) that are extendable and retractable downward from the main body 60. The chiller 26 includes a main body 80, a refrigerant inflow port 82, and a refrigerant outflow port 83. The refrigerant inflow port 82 is provided at the bottom of the main body 80, and the refrigerant outflow port 83 is provided at the ceiling of the main body 80. Inside the main body 80 of the chiller 26, the refrigerant flows from bottom to top due to the pressure of the refrigerant.

The chiller 26 includes a cooling liquid inlet and a cooling liquid outlet (not shown). The coolant inflow port and the coolant outflow port are provided on a side portion of the main body 80. The coolant inlet is provided at a higher position than the coolant outlet. A pipe 86 is connected to the coolant inlet of the chiller 26. A pipe 87 is connected to the coolant outlet of the chiller 26. The cooling liquid flows into the main body 80 of the chiller 26 via the pipe 86, and the cooling liquid flowing out of the main body 80 of the chiller 26 flows through the pipe 87. Inside the main body 80 of the chiller 26, the coolant flows from top to bottom.

As shown in FIG. 4B, the pedestal 22 includes a refrigerant inlet 30, a refrigerant outlet 32, and an opening 42. The refrigerant inlet 30 is provided on the right side surface of the pedestal 22. The refrigerant outlet 32 is provided on the upper surface of the left portion of the pedestal. The opening 42 is provided on the upper surface of the right portion of the pedestal 22.

An internal flow path 36, a reservoir 31, and a control passage 43 are provided inside the pedestal 22. The internal flow path 36 and the control passage 43 may be formed in the pedestal 22 by, for example, drilling. The internal flow path 36 is connected between the refrigerant inlet 30 and the refrigerant outlet 32. The control passage 43 is connected from the opening 42 to a part of the internal flow path 36. Each of the internal flow path 36 and the control passage 43 has a circular cross section and has a tunnel shape. The reservoir 31 is provided on the downstream side of the internal flow path 36 in the refrigerant flow direction. The refrigerant outlet 32 is provided on the upper side of the reservoir 31. The refrigerant outlet 32 is connected to the refrigerant inflow port 82 of the chiller 26.

The solenoid valve 24 comprises a rod 62 that is extendable downward from the bottom of the main body 60. The rod 62 is accessible from the opening 42 of the pedestal 22 through the control passage 43 to a portion of the internal flow path 36. In FIG. 4B, the rods 62 are shown shrunk. Further, in the drawing, the tip position of the rod 62 when the rod 62 is extended is shown by a broken line. A portion of the internal flow path 36 in which the cross section of the internal flow path 36 is changed by the rod 62 is a valve portion 64. The solenoid valve 24 controls the opening degree of the internal flow path 36 (the valve portion 64) in accordance with the amount of the rod 62 protruding to a part of the internal flow path 36.

A pipe 601 is connected to the refrigerant inlet 30 of the pedestal 22 via a joint 501. A pipe 602 is connected to the refrigerant outflow port 83 of the chiller 26 via a joint 502.

In the upper part of FIG. 3, the internal flow path 36 of the chiller unit 20 is indicated by a broken line. In the lower part of FIG. 3, as a comparative technique, a configuration in which the solenoid valve 24 and the chiller 26 are not integrated is shown. In the comparative technique, two joints 503, 504 and a pipe 603 are required between the solenoid valve 24 and the chiller 26. However, in the chiller unit 20, the two joints 503, 504 and the pipe 603 in the comparative technique can be omitted.

According to the chiller unit 20 and the other heat exchanger units described below, the number of components of the air conditioner can be reduced, and the space in the vehicle required for the air conditioner can be reduced. In addition, cost reduction, mass reduction, and improvement in assemblability of a component to a vehicle by integrating a plurality of components can be expected. In addition, since the number of parts connected is reduced, the risk of refrigerant leakage can be reduced. That is, since the necessity of replenishing the refrigerant is reduced, the burden on the user can be reduced. Further, the environmental load caused by the refrigerant leakage can be suppressed. Further, since the integration of the solenoid valve and the heat exchanger reduces the number of parts replacement steps, an improvement in serviceability can be expected.

In addition, in the refrigeration circuit using carbon dioxide as a refrigerant, since the refrigerant has a high pressure, a device having a high pressure resistance is used, and thus the device tends to be increased in size. In addition, in the refrigeration circuit of carbon dioxide, the number of components tends to increase. According to the technology of integrating the solenoid valve and the heat exchanger, it is possible to expect a reduction in the size of the refrigeration circuit of carbon dioxide and a reduction in the number of parts.

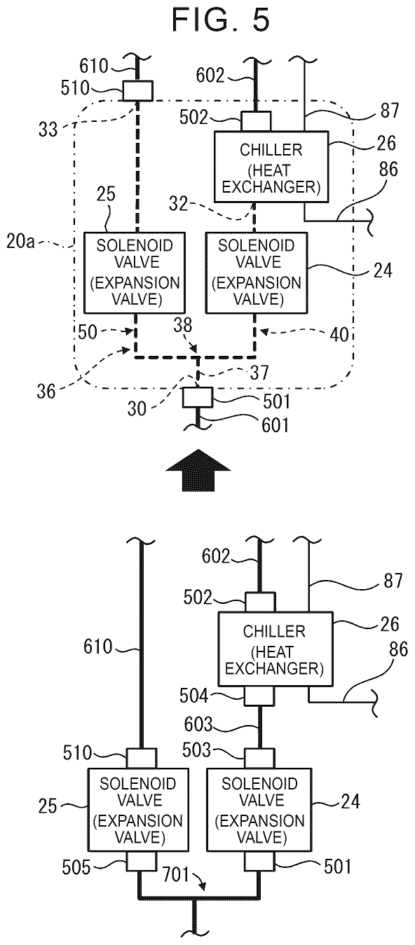

Next, another chiller unit 20a will be described. The upper part of FIG. 5 is a schematic diagram showing another chiller unit 20a, and the lower part of FIG. 5 is a schematic diagram showing a comparative technique. FIG. 6A is a perspective view schematically illustrating a chiller unit 20a. FIG. 6B is a cross-sectional view taken along VIB-VIB line of FIG. 6A. FIG. 6C is a cross-sectional view taken along VIC-VIC line of FIG. 6A.

As shown in FIG. 6A, the chiller unit 20a includes a pedestal 23, a chiller 26, a solenoid valve 24, and a solenoid valve 25. In the pedestal 23, the internal flow path 36 is changed and the second refrigerant outlet 33, the second opening 52 (see FIG. 6C), and the second control passage 53 are added to the pedestal 22 in FIG. 4A. Hereinafter, the refrigerant outlet 32, the opening 42, and the control passage 43 described with reference to FIG. 4B will be referred to as a first refrigerant outlet 32, a first opening 42, and a first control passage 43, respectively.

As shown in FIG. 6A, the chiller 26 is fixed to the upper surface of the left portion of the pedestal 23. The solenoid valve 24 is fixed to a right rear upper surface (step-up portion) of the pedestal 23. The solenoid valve 25 is fixed to a right front upper surface (step-up portion) of the pedestal 23. The chiller 26 and the solenoid valves 24 and 25 may be fixed to the pedestal 23 by screw fastening, brazing, or the like.

The solenoid valve 25 has the same structure as the solenoid valve 24. As shown in FIG. 6C, the solenoid valve 25 includes a main body 70 and rods 72 that are extendable and retractable downward from the main body 70. Hereinafter, the solenoid valve 24 and the solenoid valve 25 will be referred to as a first solenoid valve 24 and a second solenoid valve 25, respectively. Hereinafter, the rod 62 of the first solenoid valve 24 and the rod 72 of the second solenoid valve 25 are referred to as a first rod 62 and a second rod 72, respectively.

The pedestal 23 includes a refrigerant inlet 30, a first refrigerant outlet 32, a second refrigerant outlet 33, a first opening 42 (see FIG. 6B), and a second opening 52 (see FIG. 6C). The refrigerant inlet 30 is provided at a center portion of the right side surface of the pedestal 23 in the front-rear direction. The second refrigerant outlet 33 is provided at a front portion of the right side surface of the pedestal 23. The first refrigerant outlet 32 is provided on the upper surface of the left portion of the pedestal 23. The first opening 42 is provided on a right rear upper surface of the pedestal 23. The second opening 52 is provided on a right front upper surface of the pedestal 23.

Inside the pedestal 23, an internal flow path 36, a reservoir 31, a first control passage 43, and a second control passage 53 are provided. As shown in 6A, the internal flow path 36 includes an inlet flow path 37, a branch portion 38, a first flow path 40, and a second flow path 50. The inlet flow path 37 extends from the refrigerant inlet 30. The branch portion 38 is a portion that branches from the end portion of the inlet flow path 37 toward each of the first refrigerant outlet 32 and the second refrigerant outlet 33. The first flow path 40 is connected between the branch portion 38 and the first refrigerant outlet 32. The second flow path 50 is connected between the branch portion 38 and the second refrigerant outlet 33.

In FIG. 6A, a part of the first flow path 40 extending rearward from the branch portion 38 and a connecting portion c1 located at the rear end thereof are shown. The connecting portion c1 is a portion where a portion of the first flow path 40 extending in the front-rear direction intersects a portion of the first flow path 40 extending in the up-down direction (see FIG. 6B). In addition, a part of the second flow path 50 extending forward from the branch portion 38 and a connecting portion c2 located at the front end thereof are shown in FIG. 6A. The connecting portion c2 is a portion where a portion of the second flow path 50 extending in the front-rear direction intersects a portion of the second flow path 50 extending in the up-down direction (see FIG. 6C).

The reservoir 31 is provided on the downstream side of the first flow path 40 in the refrigerant flow direction. The first refrigerant outlet 32 is provided on the upper side of the reservoir 31. The first refrigerant outlet 32 is connected to the refrigerant inflow port 82 of the chiller 26.

The first control passage 43 is connected from the first opening 42 to a part of the first flow path 40. The first control passage 43 is circular in cross section and has a tunnel shape. The first solenoid valve 24 comprises a first rod 62 that is extendable downwardly from the bottom of the main body 60. The first rod 62 is reachable from the first opening 42 of the pedestal 23 through the first control passage 43 to a portion of the first flow path 40. In FIG. 6B, the first rods 62 are shown contracted. Further, in the drawing, the tip position of the first rod 62 when the first rod 62 is extended is shown by a broken line. A portion of the first flow path 40 in which the cross section of the first flow path 40 is changed by the first rod 62 is the first valve portion 64. The first solenoid valve 24 controls the opening degree of the first flow path 40 (the first valve portion 64) in accordance with the amount of the first rod 62 protruding to a part of the first flow path 40.

The second control passage 53 is connected from the second opening 52 to a part of the second flow path 50. The second control passage 53 is circular in cross section and has a tunnel shape. The second solenoid valve 25 comprises a second rod 72 that is extendable downward from the bottom of the main body 70. The second rod 72 is reachable from the second opening 52 of the pedestal 23 through the second control passage 53 to a portion of the second flow path 50. In FIG. 6C, the second rods 72 are shown shrunk. Further, in the drawing, the distal end position of the second rod 72 when the second rod 72 is extended is shown by a broken line. The portion of the second flow path 50 in which the cross section of the second flow path 50 is changed by the second rod 72 is the second valve portion 74. The second solenoid valve 25 controls the opening degree of the second flow path 50 (the second valve portion 74) in accordance with the amount of the second rod 72 protruding to a part of the second flow path 50.

A pipe and a joint similar to those of the pipe 601 and the joint 501 shown in FIG. 4B are provided at the refrigerant inlet 30 of the pedestal 23. A pipe 602 is connected to the refrigerant outflow port 83 of the chiller 26 via a joint 502. As shown in FIG. 4C, a pipe 610 is connected to the second refrigerant outlet 33 of the pedestal 23 via a joint 510.

In the upper part of FIG. 5, the internal flow path 36 of the chiller unit 20a is indicated by a broken line. In the lower part of FIG. 5, as a comparative technique, a configuration in which the solenoid valves 24 and 25 and the chiller 26 are not integrated is shown. Comparative techniques require a branch structure 701 (branch pipe), two joints 501, 505 for the two solenoid valves 24, 25, and two joints 503, 504 and pipes 603 between the solenoid valve 24 and the chiller 26. However, in the chiller unit 20a, the branch structure 701, the three joints 503, 504, 505, and the pipe 603 in the comparative technique can be omitted.

According to the chiller unit 20a described above, the same advantageous effects as those of the chiller unit 20 shown in FIGS. 3, 4A, 4B can be obtained. Further, the first solenoid valve 24 and the chiller 26 are connected by the internal flow path 36 of the pedestal 23, and the second solenoid valve 25 and the second refrigerant outlet 33 are also connected by the internal flow path 36 of the pedestal 23. Therefore, a relatively large number of parts (pipes, joints, branch pipes, and the like) of the air conditioner 12 can be reduced. Since the two solenoid valves 24 and 25 and the chiller 26 are integrated in the pedestal 23, the space in the vehicle required for the air conditioner 12 can be reduced.

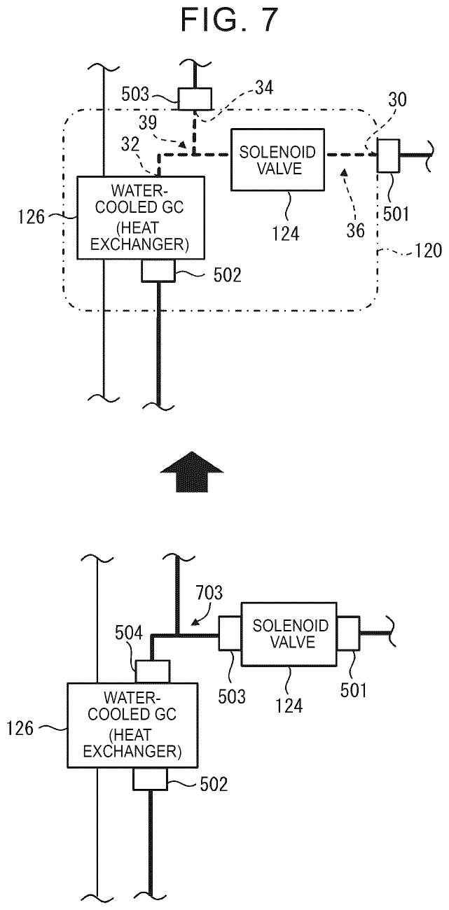

Next, the water-cooled GC unit 120 will be described. The upper part of FIG. 7 is a schematic diagram illustrating the water-cooled GC unit 120, and the lower part of FIG. 7 is a schematic diagram illustrating a comparative technique. In the water-cooled GC unit 120, a pedestal substantially the same as the pedestal 22 of the chiller unit 20 described with reference to FIGS. 4A and 4B is used. In the water-cooled GC unit 120, a water-cooled GC 126 is disposed on the pedestal instead of the chiller 26 of the chiller unit 20. In the water-cooled GC unit 120, the solenoid valve 124 is disposed on the pedestal instead of the solenoid valve 24 of the chiller unit 20.

In the upper part of FIG. 7, the internal flow path 36 of the pedestal of the water-cooled GC unit 120 is indicated by a broken line. The internal flow path 36 of the pedestal of the water-cooled GC unit 120 has a branch portion 39 added between the solenoid valve 124 and the water-cooled GC 126 with respect to the internal flow path 36 (see the upper portion in FIG. 3) of the pedestal 22 of the chiller unit 20. In the water-cooled GC unit 120, a branch portion 39 is provided between the valve portion 64 and the refrigerant outlet 32 in the pedestal 22 (refer to FIG. 4B). In the water-cooled GC unit 120, as shown in the upper part of FIG. 7, an internal flow path 36 connected from the branch portion 39 to another refrigerant outlet 34 is provided. The refrigerant outlet 34 is provided on the rear surface of the pedestal. A pipe is connected to the refrigerant outlet 34 via a joint 503.

In the lower part of FIG. 7, a configuration in which the solenoid valve 124 and the water-cooled GC 126 are not integrated is shown as a comparative technique. In the comparative technique, two joints 503, 504 and a branch structure 703 (branch pipe) are required between the solenoid valve 124 and the water-cooled GC 126. However, in the water-cooled GC unit 120, the joint 504 and the branch structure 703 in the comparative technique can be omitted. In the water-cooled GC unit 120 described above, the same advantageous effects as those of the chiller unit 20 shown in FIGS. 3, 4A, 4B can be obtained.

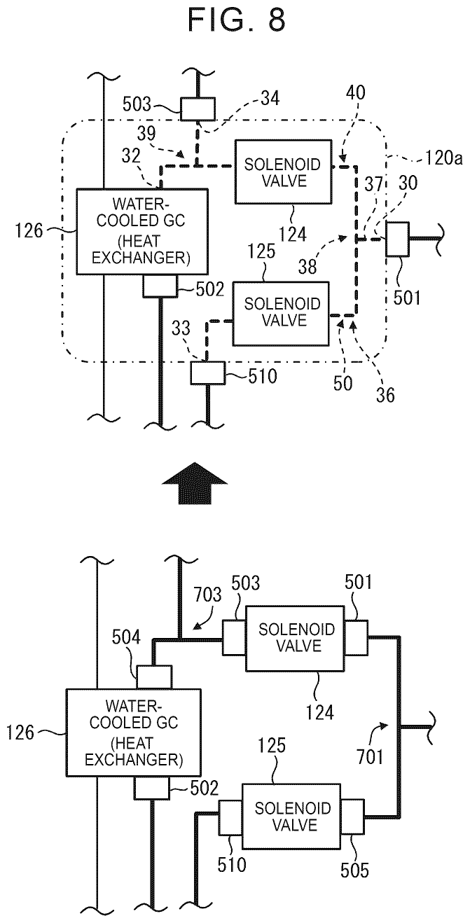

Next, the water-cooled GC unit 120a will be described. The upper part of FIG. 8 is a schematic diagram showing a water-cooled GC unit 120a, and the lower part of FIG. 8 is a schematic diagram showing a comparative technique. In the water-cooled GC unit 120a, substantially the same pedestal as the pedestal 23 of the chiller unit 20a described with reference to FIG. 6A, FIG. 6B, and FIG. 6C is used. In the water-cooled GC unit 120a, a water-cooled GC 126 is disposed on the pedestal instead of the chiller 26 of the chiller unit 20a. In the water-cooled GC unit 120a, the solenoid valve 124 is disposed on the pedestal instead of the solenoid valve 24 of the chiller unit 20a, and the solenoid valve 125 is disposed on the pedestal instead of the solenoid valve 25 of the chiller unit 20a.

In the upper part of FIG. 8, the internal flow path 36 of the pedestal of the water-cooled GC unit 120a is indicated by a broken line. In the internal flow path 36 of the pedestal of the water-cooled GC unit 120a, a branch portion 39 is added between the solenoid valve 124 and the water-cooled GC 126 with respect to the internal flow path 36 (refer to the upper portion in FIG. 5) of the pedestal 23 of the chiller unit 20a. In the water-cooled GC unit 120a, a branch portion 39 is provided between the first valve portion 64 and the first refrigerant outlet 32 in the pedestal 23 (see FIG. 6B). In the water-cooled GC unit 120a, as shown in the upper part of FIG. 8, an internal flow path 36 is provided which is connected from the branch portion 39 to another refrigerant outlet 34. The refrigerant outlet 34 is provided on the rear surface of the pedestal. A pipe is connected to the refrigerant outlet 34 via a joint 503.

In the lower part of FIG. 8, as a comparative technique, a configuration in which the solenoid valve 124, 125 and the water-cooled GC 126 are not integrated is shown. The comparative technique requires two branch structures 701, 703 (branch pipes), two joints 501, 505 for the two solenoid valves 124, 125, and two joints 503, 504 between the solenoid valves 124 and the water-cooled GC 126. However, in the water-cooled GC unit 120a, the two branch structures 701, 703 and the two joints 504, 505 in the comparative technique can be omitted. Also in the water-cooled GC unit 120a described above, it is possible to obtain the same advantageous effects as those of the chiller unit 20a of FIGS. 5, 6A, 6B, and 6C.

What is claimed is:

1. A vehicle air conditioning device comprising:
a refrigeration circuit which includes a solenoid valve and a heat exchanger provided on a downstream side of the solenoid valve in a refrigerant flow direction, and in which a refrigerant circulates; and
a pedestal to which the solenoid valve and the heat exchanger are fixed, wherein:
the pedestal includes a refrigerant inlet, a refrigerant outlet connected to a refrigerant inflow port of the heat exchanger, an internal flow path having a tunnel shape and connected between the refrigerant inlet and the refrigerant outlet, an opening, and a control passage connected from the opening to a portion of the internal flow path; and
the solenoid valve includes a rod that is able to reach the portion of the internal flow path from the opening of the pedestal through the control passage, and the solenoid valve controls an opening degree of the internal flow path in accordance with an amount by which the rod projects toward the portion of the internal flow path.

2. The vehicle air conditioning device according to claim 1, wherein:
the solenoid valve is an expansion valve that reduces a pressure of the refrigerant; and
the heat exchanger is a chiller into which the refrigerant and a cooling liquid flow and in which the refrigerant is evaporated to absorb heat of the cooling liquid.

3. The vehicle air conditioning device according to claim 1, wherein:
the solenoid valve is a control valve that switches opening and closing of the internal flow path; and
the heat exchanger is a refrigerant cooler into which the refrigerant and a cooling liquid flow and in which the refrigerant is cooled by the cooling liquid.

4. A vehicle air conditioning device comprising:
a refrigeration circuit which includes a first solenoid valve, a second solenoid valve, and a heat exchanger, and in which a refrigerant circulates; and
a pedestal to which the first solenoid valve, the second solenoid valve, and the heat exchanger are fixed, wherein:
the pedestal includes a refrigerant inlet, a first refrigerant outlet connected to a refrigerant inflow port of the heat exchanger, a second refrigerant outlet, and an internal flow path having a tunnel shape;
the internal flow path of the pedestal includes an inlet flow path that extends from the refrigerant inlet, a branch portion that branches from the inlet flow path toward each of the first refrigerant outlet and the second refrigerant outlet, a first flow path connected between the branch portion and the first refrigerant outlet, and a second flow path connected between the branch portion and the second refrigerant outlet;
the pedestal includes a first opening and a first control passage connected from the first opening to a portion of the first flow path, the first solenoid valve includes a first rod that is able to reach to the portion of the first flow path from the first opening of the pedestal through the first control passage, and the first solenoid valve controls an opening degree of the first flow path in accordance with an amount by which the first rod projects toward the portion of the first flow path; and
the pedestal includes a second opening and a second control passage connected from the second opening to a portion of the second flow path, the second solenoid valve includes a second rod that is able to reach to the portion of the second flow path from the second opening of the pedestal through the second control passage, and the second solenoid valve controls an opening degree of the second flow path in accordance with an amount by which the second rod projects toward the portion of the second flow path.
